(19) United States
(12) Patent Application Publication
(10) Pub. No.: US 2025/0209338 A1
(43) Pub. Date: Jun. 26, 2025

(54) EXPLORATION BY BOOTSTRAPPED PREDICTION

(71) Applicant: DeepMind Technologies Limited, London (GB)

(72) Inventors: Zhaohan Guo, London (GB); Florent Altché, Paris (FR); Corentin Tallec, Paris (FR); Bernardo Avila Pires, London (GB); Miruna Pîslar, Paris (FR); Shantanu Yogeshraj Thakoor, London (GB); Mohammad Gheshlaghi Azar, Seattle, WA (US); Bilal Piot, London (GB)

(21) Appl. No.: 18/850,206

(22) PCT Filed: May 17, 2023
(86) PCT No.: PCT/EP2023/063282

§ 371 Date: Sep. 24, 2024

Related U.S. Application Data
(60) Provisional application No. 63/343,798, filed on May 19, 2022.

(51) Int. Cl. G06N 3/092; G06N 3/045

(52) U.S. Cl. CPC G06N 3/092; G06N 3/045

(57) ABSTRACT

An iterative method is proposed to train an action selection system of a reinforcement learning system, based on a reward function which defines a reward value for each action. The reward value includes an intrinsic reward term generated based on the outputs of two encoder models: an online encoder model and a target encoder model. The online encoder model is iteratively trained based on a loss function, and the target encoder model is updated to bring it closer to the online encoder model.

### CROSS-REFERENCE TO RELATED APPLICATIONS

This application claims priority to U.S. Provisional Application Ser. No. 63/343,798 filed on May 19, 2022, the disclosure of which is incorporated in its entirety into this application.

### BACKGROUND

This specification relates to machine learning, and in particular machine learning for reinforcement learning (RL).

In a reinforcement learning system, an agent interacts with an environment, e.g., a real-world environment, by performing actions that are selected by the reinforcement learning system in response to receiving successive “observations”, i.e. datasets that characterize the state of at least part of the environment at corresponding time-steps, e.g., the outputs of sensor(s) which sense at least part of the real world environment at those time-steps.

The way in which a reinforcement learning system selects the actions based on the observations is referred to as a “control policy”. Some reinforcement learning systems select the action to be performed by the agent in response to receiving a given observation in accordance with an output of a neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters, sometimes referred to as “weights”.

Some neural networks are recurrent neural networks. A recurrent neural network (RNN) is a neural network that receives an input sequence and generates an output sequence from the input sequence. In particular, a recurrent neural network can use some or all of the state of the network from a preceding time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

The present disclosure describes a system implemented as computer programs on one or more computers in one or more locations that updates a control policy for generating actions to be performed by at least one agent to interact with an environment.

In general terms, the disclosure suggests that an iterative method to train a control policy is based on a reward function which defines a reward value for each action, and that the reward value includes a reward term (an “intrinsic reward” term, also called here an intrinsic reward value) generated based on the outputs of two encoder models: an online encoder model and a target encoder model. Each encoder model is operative to receive observations of the environment, and to generate corresponding datasets referred to as observation-representations. In particular, the data size of the observation-representations is typically smaller, e.g. at least a factor of 10 smaller, than the data size of the observations. The observation-representations are points in a space referred to as a “latent space”, having a dimensionality equal to the data size of the observation-representations.

The intrinsic reward for each action is based on a predictive loss value for one or more future observations, i.e. observations after the action. The predictive loss value characterizes a discrepancy (difference) between a prediction of an observation-representation for the observation, and an observation-representation of the (actual) observation. The sum of the respective predictive loss values for the observations after the action is termed a prediction loss function. A high prediction loss function indicates that the predictions are poor. This in turn suggests that the action is a valuable one, since it identifies a weakness of the predictions, and thereby gives an opportunity to improve the mechanism for making the predictions. Thus, choosing a control policy so as to increase the expected intrinsic reward term corresponds to adapting the control policy so that it is more likely to choose actions which enable the predictions to be improved, and thus to gain valuable information about the environment.

For example, one of the encoder models (typically, the online encoder model) may be used to generate an observation-representation of a current observation, e.g. the observation for the same time-step as the action for which the reward value is being determined. This observation-representation is used by a predictive unit, e.g. comprising a recurrent unit, as discussed below, to generate K predictions (where K is an integer termed a “horizon” which is at least one, and may be greater than one, i.e. at least two, and optionally at least three) of the respective observation-representations for K successive future observations, e.g. the observations for the K time-steps following the action for which the reward value is being determined. To do this, the predictive unit may receive information about the action for which the reward value is being determined, and the K−1 successive actions. The encoder model and the predictive unit together form what can be referred to as an adaptive “world model”, where the encoder model is an adaptive world representation, and the predictive model adaptively encodes world dynamics. The respective predictive loss value for each of the K predicted observation-representations is a measure of the discrepancy (difference) between the prediction and the observation-representation of the corresponding actual observation. The observation-representations of the actual observations may be produced by the other of the encoder models (typically, the target encoder model).

The control policy is defined by a “policy” neural network, and the online encoder model and target encoder model are defined respectively by an online encoder neural network and a target encoder neural network. All these neural networks are defined by corresponding adaptive parameters, e.g. weights, which are trained by successive updates. The predictive unit is defined by further adaptive parameters (e.g. as explained below the predictive unit may include one or more recurrent neural networks (RNN), and the adaptive parameters are parameters of the RNNs).

Many reinforcement learning (RL) algorithms are known for training a control policy (that is, training the policy neural network) based on reward values for actions generated by the control policy, and any such RL algorithm may be employed in the present system. RL algorithms typically, though not always, operate to increase the expected reward value for actions chosen by the control policy.

At least the online encoder model and the target encoder model may be trained jointly (here “joint training” of two models means that updates to the two models are interleaved or updates to one model are substantially simultaneous with respective updates to the other model), and both may be trained jointly with the predictive unit.

In principle, the online encoder model and target encoder model can be trained before the control model. However, in other embodiments the control policy is jointly trained with the online encoder model and the target encoder model, based on the reward values. Thus, a world representation (the online encoder model), world dynamics (the predictive model) and the exploration policy (control model) are optimized together, such as based on a single prediction loss in the latent space with no additional auxiliary objective (e.g. no reward term which is not based on a (non-exploration) task the agent is to perform in the environment).

Each of the encoder models, the predictive model and the control policy may initially be randomly selected or set to default setting(s). The training of the encoder models, the predictive model and the control policy is based on sequences of observations and corresponding actions. These sequences are taken from a training database of trajectories. Each trajectory is a series of actions previously performed by the agent at successive time-steps and corresponding observations. A given sequence may be generated by selecting a time-step of a selected one of the trajectories, and then defining the sequence comprising the action and observation of the selected trajectory for the selected time-step and of a certain number K of successive time steps. In implementations, the joint training of the encoder models and the predictive unit is based on minimization of the same function, that is, a sum over the sequences of a sum of the predictive loss value for the K observations which follow the first observation of the sequence.

One or more of the training iterations for the encoder networks, the control policy and the predictive unit may be based on a batch of the trajectories. In an example implementation explained below, the trajectories of a batch are labeled with an integer variable j where j=0, . . . , B−1, and B denotes the number of trajectories in the batch.

As the control policy is trained, it may be successively employed to generate a new trajectory, by, starting from an initial state of the environment, selecting a series of successive actions which are performed by the agent, thereby generating a series of successive observations. This process may be repeated, e.g. using a different initial state each time, to generate a plurality of new trajectories. Each new trajectory may be added to the training database. Training the control policy jointly with the encoder models and predictive unit has an advantage that the trajectories in the training database may be supplemented with trajectories produced using the semi-trained control model, which may be more useful than the original trajectories in the training database for training the encoder models and predictive unit.

One or more training iterations (e.g. generating updates in each iteration to both the encoder models, the predictive unit and the control policy) may be performed for each batch of trajectories, and then a new batch of trajectories may be selected from the training database.

Denoting a time-step selected from a j-th trajectory of a certain batch by t, denoting the corresponding observation by oₜ^{j}, and denoting the corresponding action (i.e. the action chosen based on the observation oₜ^{j}) by aₜ^{j}, a sequence may for example be {oₜ^{j}, aₜ^{j}, oₜ₊₁^{j}, aₜ₊₁^{j}, . . . , o_{t+K-1}^{j}, a_{t+K-1}^{j}, o_{t+K}^{j}}. Thus, the sequence includes a first observation oₜ^{j} and K successive observations, as well as the K actions which immediately preceded the K successive observations. The sequence may alternatively be defined to include aₜ₋₁^{j} in addition, so that the sequence is K+1 action-observation pairs, each of which is an action at a given time step and the observation at the following time-step.

Denoting the online encoder model as f_{θ}, the online encoder model may receive oₜ^{j} and from it generate an observation-representation f_{θ}(oₜ^{j}). The predictive unit may receive f_{θ}(oₜ^{j}) and from it generate predictions of observation-representations of the K successive observations oₜ₊₁^{j}, . . . , o_{t+K}^{j}. The respective K predictive loss values are obtained by comparing these K predictions with observation-representations generated from the actual oₜ₊₁^{j}, . . . , o_{t+K}^{j} (i.e. the actual observations for the corresponding time-steps of the sequence) by the target encoder model, which may be denoted f_{ϕ}.

To generate the K predictions, the predictive unit may include a first recurrent neural network (below termed an “open-loop RNN cell”). The first recurrent neural network may generate the K predictions in K respective steps. In a first step, the first recurrent neural network receives an input (in an example implementation denoted bₜ, or in a more precise notation bₜ^{j}) based on the observation-representation f_{θ}(oₜ^{j}) generated by the online encoder model upon receiving the first observation oₜ^{j} of the sequence, and generates a corresponding value b_{t,1} (or in a more precise notation b_{t,1}^{j}). At each of the subsequent K−1 steps, the first recurrent network receives the output of the first recurrent network for the previous step, and in these K−1 steps the first recurrent network generates successive values b_{t,2}, . . . , b_{t,K} (or in a more precise notation b_{t,2}^{j}, . . . b_{t,K}^{j}). In each of the K steps, the first recurrent network may further receive the action for the preceding corresponding time-step, i.e. aₜ^{j}, . . . , a_{t+K-1}^{j}.

A predictor unit (performing a function denoted g_{θ}) generates the K predictions of the observation-representations for the K successive observations following oₜ^{j} (i.e. oₜ₊₁^{j}, oₜ₊₂^{j}, . . . , o_{t+K}^{j}) based on the K respective outputs of the first recurrent network, i.e. in the example b_{t,1}^{j}, . . . b_{t,K}^{j} respectively.

Optionally, a training iteration may comprise following a trajectory (e.g. from the start), and for each time step of the trajectory (except perhaps the first) defining a corresponding sequence which is used to form an update to the online encoder model (that is, to the variable parameters defining the online encoder neural network), the predictive unit and optionally the policy neural network. The target encoder model may then be updated based on the online encoder model. Optionally, the predictive unit further includes a recursive cell defined by a second recurrent neural network (below termed a “closed-loop RNN cell”) which has a state which evolves along the trajectory. For each time-step t of the trajectory, the output of the second recurrent neural network is denoted bₜ, or in the more precise notation by bₜ^{j}. For each time step/of the trajectory except the first, the recurrent neural network neural network may receive the corresponding output (below denoted in an example bₜ₋₁ (or in the more precise notation by bₜ₋₁^{j})) of the second recurrent network at the preceding time-step of the trajectory.

The second recurrent network may be configured also to receive, for each time-step of the trajectory, an input which is the observation-representation f_{θ}(oₜ^{j}) generated by the online encoder model based on the observation oₜ^{j} for the time step (i.e. the first observation of the sequence). It may also receive as an input the action aₜ₋₁^{j} for the preceding time step of the trajectory.

The input to the first recurrent network in the first of the K predictive steps it performs, i.e. the input which, as mentioned above, is based on the observation-representation f_{θ}(oₜ^{j}) generated by the online encoder model upon receiving the first observation oₜ^{j} of the sequence, may be the output bₜ (or more precisely bₜ^{j}) of the second recurrent neural network.

The predictive loss value for the observation oₜ₊ₖ^{j} is denoted in the example implementation by [symbol] _{BYOL-Explore}(θ, j, t, k), and is an error measure characterizing the difference (e.g. Euclidean difference) between the k-th prediction g_{θ}(b_{t,k}^{j}) and the observation-representation f_{θ}(oₜ₊ₖ^{j}) of the actual observation oₜ₊ₖ^{j}. As part of the definition of the error measure, g_{θ}(b_{t,k}^{j}) may optionally be normalized, e.g. based on a Euclidean measure of the respective magnitudes of g_{θ}(b_{t,k}^{j}) over the possible observations. Similarly, f_{ϕ}(oₜ₊ₖ^{j}) may optionally be normalized, e.g. based on a Euclidean measure of the respective magnitudes of f_{ϕ}(oₜ₊ₖ^{j}) over the possible observations. Term(s) in the predictive loss value based on f_{ϕ}(oₜ₊ₖ^{j}) may not be back-propagated in the algorithm to update parameters of the target encoder model; the target encoder model may (only) be updated as described below based on the current online encoder model.

The predictive unit is also used to form the reward values, by defining the prediction loss function lₜ^{j} for a given action aₜ^{j} of one of trajectories as a sum, over a plurality of observations following the action, of the predictive loss value for the observations.

The prediction loss function lₜ^{j} may be normalized to form the intrinsic reward using a normalization parameter σᵣ indicative of the variance of the respective prediction loss functions for a plurality of actions. This normalization is valuable because, as the world model becomes more accurate, the prediction loss function may become small, which without the normalization might result in undesirably small intrinsic reward terms.

Optionally, there may be a step of determining whether the normalized intrinsic reward value is below a threshold η, and (only) upon the determination being positive, the normalized intrinsic reward value is reduced, e.g. to zero; or at least compared to normalized intrinsic reward values above the threshold. This has the advantage that the control policy is encouraged to generate actions which prioritize exploring regions of the environment where errors made by the world model are highest, rather than being distracted by seeking to reduce small predictive errors in regions of the environment where the world model is already fairly accurate. The threshold η may optionally be progressively reduced during the training, so that there are at least some areas of the embodiment for which the predictive error is above the threshold.

The target encoder model may be trained simply by updating it periodically to make it closer to the online encoder model in its current state. For example the target encoder model may an exponential moving average of the online encoder model. In variations, the target encoder model may be any other average of a certain number of the past versions of the online encoder model, e.g. an equally weighted average of a certain number N of the past versions of the online encoder model.

The concept of an online encoder model which is updated based on a loss function, and a target encoder model which is updated based on current states of the encoder model, is motivated by the BYOL approach to self-supervised learning (Grill et al, “Bootstrap your own latent: A new Approach to Self-Supervised Learning”, 2020), which also employs an online encoder and a target encoder, but in that paper the training of the online encoder was not based on observations of an evolving environment. Analogously to the situation described in that paper, it is somewhat surprising in the present context that the present techniques are effective, rather than resulting in a “collapse”. For example, it is not obvious why the present encoder networks should not evolve to a trivial form in which the observation-representations are the same for all possible observations, so that predicting observation-representations of future observations is easy. In fact, however, it is observed experimentally that this collapse does not happen. Instead, the encoder networks are found experimentally to evolve into a form which emphasize characteristics of the observations which are most valuable for predicting observation-representations of future observations. Intuitively, in early training the target encoder model is initialized randomly, so the online network (i.e. the combination of the online encoder model and predictive unit) are trained to predict random features of the future. This encourages the online encoder model to capture information which is useful to predict the future. This information is then distilled into the target encoder model though the moving average slow copy mechanism. In turn, these features become targets for the online network, and predicting them further improves the quality of the online encoder model.

The policy network may take any form known in the reinforcement learning field. As in known policy networks, the output of the policy network, having processed an observation as an input, may comprise respective numerical values for each of a set of possible actions, and the action selected by the control policy may be determined based on these numerical values. For example, the selected action may be the action for which the respective numerical value is highest, or the selected action may be the result of applying a softmax function to the numerical values, or the numerical values may be treated as being proportional to respective probabilities and the action may be selected as a random selection from the possible actions according to the respective probabilities.

Optionally, the policy network may comprise an input section which is an encoder network for receiving an observation and generating an observation-representation. The encoder network may optionally be the same as the online encoder model. Thus, a further benefit is drawn from the effort of generating the online encoder model.

Some known control policies use a predictive model to select an action (e.g. by using the predictive model to predict sets of observations which would result from the control policy selecting corresponding sequences of actions; measuring a quality value of each set of observations according to a quality criterion, e.g. a quality criterion which measures how well the set of observations indicate that a task has been correctly performed; and then selecting the action to be the first action of a sequence for which the quality value of the corresponding observations is highest). The present control policy may employ some or all of the predictive unit in a predictive model of the control policy, such as one or both of the recurrent neural networks. Thus, a further benefit is drawn from the effort of generating the predictive unit.

For example, the predictive model may include a control policy first recurrent cell having the same parameters as the closed-loop recurrent cell. The control policy first recurrent cell may be arranged to receive, for each time-step of a trajectory (that is, a sequence of observations of the environment and corresponding actions generated by the control policy and performed by the agent) an observation-representation of a current observation generated by the online encoder model, and, except the first time-step of the trajectory, the output of the first recurrent cell at the preceding time step and optionally the action from the preceding time-step; and a control policy second recurrent cell having the same parameters as the open-loop recurrent cell, and arranged to receive an output of the first recurrent cell and a sequence of actions (e.g. K actions) proposed by the control policy, and to generate data from which a predictive model (e.g. the predictive unit) predicts observation-representations of successive observations (e.g. K predicted successive observations) resulting from performing the sequence of actions in successive time-steps. This procedure may be carried out for multiple possible sequences of actions, in each case applying a quality criterion to the corresponding predicted observation-representations to derive a corresponding quality value for the sequence of actions. Then the control policy may determine which sequence has the highest quality value, and select the action as the first action of the sequence having the highest quality value.

As discussed, the intrinsic reward term encourages the control policy to be trained to explore the environment. The reward value for each action may further include at least one reward term (“extrinsic reward term” or “task reward”) associated with at least one corresponding task, and indicative of a degree to which the action contributes to performance of the corresponding task. In this case, the control policy is trained both to cause the agent to explore the environment and to perform the task(s), with the gradually increasing knowledge of the environment contributing to solving the task(s). For some tasks, the corresponding extrinsic reward term can be generated straightforwardly and directly based on rewards defined by the task. Alternatively, particularly for tasks with sparse rewards, the corresponding extrinsic reward term may be generated by any technique of known reinforcement learning systems, such as based on a Q-network as in a known Q-learning reinforcement learning technique.

In one example, the algorithm is one such as V-based Maximum a Posteriori Policy Optimization (V-MPO) (see H. Francis Song et al, “V-MPO: On-Policy Maximum A Posteriori Policy Optimization for Discrete and Continuous Control”, 2019, https://arxiv.org/pdf/1909.12238.pdf), which, as an alternative to policy gradient-based algorithms, is an approximate policy iteration algorithm in an on-policy setting. This type of RL algorithm uses a learned state-value function V(s) instead of a state-action value function. Rather than directly updating the parameters in the direction of the policy gradient, V-MPO first constructs a target distribution for the policy update subject to a sample-based KL constraint, then calculates the gradient that partially moves the parameters toward that target, again subject to a KL constraint.

In some implementations, following the training of the online encoder model and the predictive unit jointly with a control policy using a reward term which does not include an extrinsic reward term, a new control policy can be defined incorporating the online encoder model as an encoder, and optionally the predictive unit as a predictive model, and the new control model can be trained by reinforcement learning based on a reward value including at least one extrinsic reward term associated with at least one corresponding task, e.g. without the reward value including an intrinsic reward term. Thus, this implementation makes use of the intrinsic reward term during a process in which the online encoder model and the predictive unit are developed, so as to produce a high-quality world model, but then uses the trained high-quality world model to train another control policy (policy neural network) using one or more extrinsic reward values for actions which reflect how well those actions contribute to performing corresponding tasks.

In either case, once the policy neural network has been trained, it can be used to generate actions to be performed by the agent based on corresponding observations of the environment, e.g. so as to control the agent to perform the at least one task. Optionally, the training of the policy network by the present methods may be performed in a simulated version of the environment using a simulated agent, and the trained network may be employed to control a (real) agent in a real-world environment.

A technical effect of the present disclosure is to generate a control policy, in some examples using a simple architecture, which selects actions to explore an environment effectively. This exploration has been demonstrated experimentally to be useful in solving a variety of hard reinforcement learning problems, including ones with sparse rewards. Furthermore, it is applicable to reinforcement learning problems involving partially observable, multi-task and stochastic environments, whereas some known techniques for encouraging the control policy to use the agent to explore the environment are designed for single-task training, or have limited success beyond a specific domain. In particular, example systems according to the present disclosure are successful for tasks which can only be successfully performed by a coordinated series of actions (e.g. up to K actions). For example, it has been demonstrated experimentally that certain implementations of the present techniques perform complex 3-D navigation and manipulation tasks which were previously only solvable by reinforcement learning techniques employing human demonstrations. Avoiding the need for such demonstrations reduces the cost of training the control policy, because human demonstrations are expensive to produce.

As noted above, in principle, the online encoder model and target encoder model can be trained before the control model. Indeed, doing this can produce a useful encoder of observations which, in an alternative independent aspect of the disclosure, is used to encode observations when training an reinforcement learning system by an (e.g. conventional) reinforcement algorithm which uses only reward values which are task rewards, or task rewards plus an intrinsic reward value which is produced by a known method, rather than by the method explained above.

Accordingly this second aspect of the disclosure proposes a method performed by one or more computers for learning a control policy, the control policy being for generating successive actions at each of corresponding successive time-steps to be performed by an agent interacting with an environment, based on observations characterizing the environment at the respective ones of the time-steps,
the method employing an online encoder model and a target encoder model, which are each operative, upon receiving an observation, to generate an observation-representation, as data in a latent representation space,
wherein the online encoder model, the target encoder model and the control policy are trained by an iterative process of making respective updates to them based on sequences of observations and corresponding actions, at least the online encoder model and the target encoder model being trained jointly,
the iterative process including repeatedly:
updating the online encoder model to reduce a sum over the sequences of a predictive loss value for at least one observation of each sequence, the predictive loss value of each observation being indicative of a discrepancy between a prediction of an observation-representation of the observation and an observation-representation of the observation obtained using one of the encoder models;
updating the target encoder model based on the current state of the online encoder model; and
updating the control policy based on reward values for corresponding actions included in corresponding ones of the sequences, the control policy comprising an encoder model based on at least one of the target encoder model and the online encoder model.

### BRIEF DESCRIPTION OF THE DRAWINGS

FIG. 1 shows an example action selection system.

FIG. 2 shows the structure of a first policy neural network which can be trained by example methods.

FIG. 3 shows the structure of a second policy neural network which can be trained by example methods.

FIG. 4 shows the operation of an example predictive unit and two example encoder networks.

FIG. 5 is a flow diagram of an example process for selecting a control input.

FIG. 6 shows the structure of a third policy neural network which can be trained by example methods.

FIG. 7 shows the structure of a fourth policy neural network which can be trained by example methods

FIG. 8 shows experimental results of the performance of two agents controlled by example action selection systems, and three comparative examples.

Like reference numbers and designations in the various drawings indicate like elements.

### DETAILED DESCRIPTION

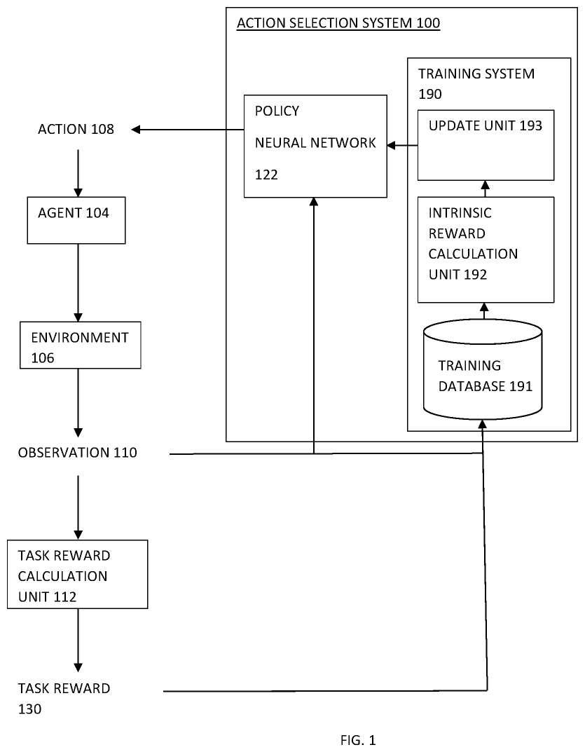

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple time steps during the performance of an episode of the task.

As a general example, the task can include one or more of, e.g., navigating to a specified location in the environment, identifying a specific object in the environment, manipulating the specific object in a specified way, controlling items of equipment to satisfy criteria, distributing resources across devices, and so on.

More generally, the task is specified by received rewards, e.g., such that an episodic return is maximized when the task is successfully completed. Rewards and returns will be described in more detail below. Examples of agents, tasks, and environments are also provided below.

An “episode” of a task is a series of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step/(where/is an integer, that is t∈ [symbol] ) during any given task episode, the system 100 receives an observation 110, denoted oₜ, which is a member of a space of possible observations [symbol] , characterizing the current state of the environment 106 at the time step and, in response, selects an action 108, denoted aₜ, which is a member of a space of possible actions [symbol] , to be performed by the agent 104 at the time step. An action to be performed by the agent will also be referred to in this specification as a “control input”. After the agent performs the action 108, the environment 106 transitions into a new state. A new observation 110, denoted oₜ₊₁, is then generated. The series of observations {oₜ} and actions {aₜ} generated during an episode forms a trajectory. The environment has a dynamics which maps a history ( [symbol] = [symbol] [symbol] ₜ where [symbol] ₀∈ [symbol] , and [symbol] ₜ₊₁= [symbol] ₜ× [symbol] × [symbol] ) of past observation-action pairs and a current action at to a probability distribution over future observations oₜ₊₁.

A task reward calculation unit 112 generates an extrinsic reward (“task reward”) 130, denoted rₜ, which is generally a scalar numerical value and characterizes the progress of the agent 104 towards completing the task. In a simple case, the task reward may be based on oₜ. As a particular example, the reward 130 can be a sparse binary reward that is zero unless the task is successfully completed as a result of the action being performed, i.e., is only non-zero, e.g., equal to one, if the task is successfully completed as a result of the action performed.

As another particular example, the task reward 130 can be a dense reward that measures a progress of the agent towards completing the task as of individual observations received during the episode of attempting to perform the task, i.e., so that non-zero rewards can be and frequently are received before the task is successfully completed. Yet, more generally the task reward r: [symbol] × [symbol] → [symbol] maps a history of past observations-actions to a real number.

The action 108 at each time step is selected by a policy neural network 122 of the action selection system 100 based on the observations. The policy neural network 122 implements a “control policy”. For example, action 108 for time step t, that is, aₜ, may be selected based just on the observation 110 for that time step, that is, oₜ. More generally, control policies π: [symbol] → [symbol] may be considered which map a history of past observations-actions to a probability distribution over actions (a “policy output”), and an action selection unit of the policy neural network 112 selects an action 108, e.g. by sampling from that probability distribution, or by selecting the action 108 with the highest probability value.

Many reinforcement learning algorithms are known which train the policy neural network 122. Many of these algorithms train the policy neural network in each given episode, to select actions in order to attempt to maximize a “return” that is received over the course of the task episode. That is, at each time step during the episode, the policy neural network 122 selects actions that attempt to maximize the return that will be received for the remainder of the task episode starting from the time step. Generally, at any given time step, the return that will be received is a combination of the rewards that will be received at time steps that are after the given time step in the episode. For example, at a time step t, the return may be Σᵢ(γ^{i-t-1}rᵢ), where i ranges either over all of the time steps after t in the episode or for some fixed number of time steps after t within the episode, γ is a discount factor that is greater than zero and less than or equal to one, and rᵢ is the reward at time step i.

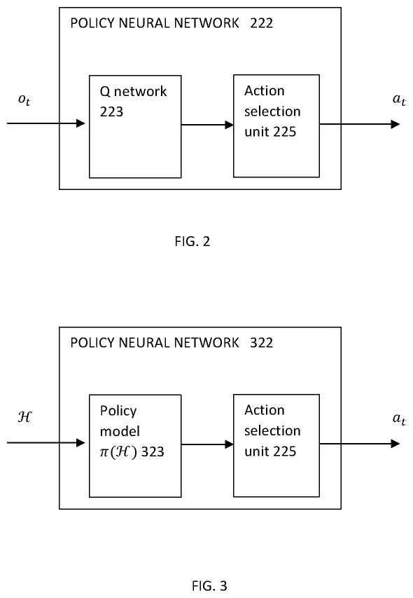

One example of a possible policy neural network 122 is illustrated in FIG. 2 as policy neural network 222. This includes a “Q network” 223 which generates (e.g. from observation oₜ) a respective Q-value for each action in the fixed set. The Q network 223 can process the Q-values (e.g., using a soft-max function) to generate a respective probability value for each action, which can be used by an action selection unit 225 to select the action (as described earlier), or can select the action with the highest Q-value.

The Q-value for an action is an estimate of a return that would result from the agent performing the action in response to the current observation and thereafter selecting future actions performed by the agent in accordance with current values of the parameters of the control policy neural network 122.

As another example, when the action space is continuous, the policy output can include parameters of a probability distribution over the continuous action space and the action selection unit 225 can select the action by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 100.

As yet another example, when the action space is continuous, the policy output can include a regressed action, i.e., a regressed vector representing an action from the continuous space, and the system 102 can select the regressed action as the action 108.

FIG. 3 shows, as policy neural network 322, another possible form of the policy neural network 122 of FIG. 1, which is more general than the policy network 222 of FIG. 2. In this case, the policy neural network 322 receives the entire history of observations and actions, and the policy model 323 generates the policy output based on it. Again, an action selection unit 225 selects an action 108 based on the policy output.

Returning to FIG. 2, the policy neural network 122 is trained by a training system 190. This comprises a training database 191 which stores data collected in a plurality of episodes. This data is the trajectories, and the corresponding task rewards generated during the trajectories. Each trajectory is assumed to contain data for T time steps, where T is an integer greater than one (typically, much greater than one, such as at least 10, or at least 30). These time steps are labelled by an integer index t=0, . . . , T−1. Batches of trajectories are selected from the training database 191, and used by an update unit 193 of the training system to generate an update to the policy neural network 122. The update unit 193 can generate updates according to various known algorithms, based on the trajectories and, for each time step of each trajectory, a corresponding reward value. In the action selection system of 122, the reward values used by the update unit 193 are not just the task rewards, but instead, for each time step of each trajectory in the batch, the sum of the corresponding task reward and an intrinsic reward calculated by an intrinsic reward calculation unit 192.

The operation of the policy neural network 122 is defined by a plurality of trainable numerical parameters (typically at least millions of such parameters) as is the operation of the intrinsic reward calculation unit 192. The policy neural network 122 and intrinsic reward calculation unit 192 may optionally be trained jointly (another possibility is described below). In this case, as the control policy is trained, it may be successively employed to generate new trajectories which are added to the training database 191, by, starting from an initial state of the environment 106, selecting a series of successive actions which are performed by the agent 104, thereby generating a series of successive observations 100. This process may be repeated, e.g. using a different initial state each time, to generate a plurality of new trajectories.

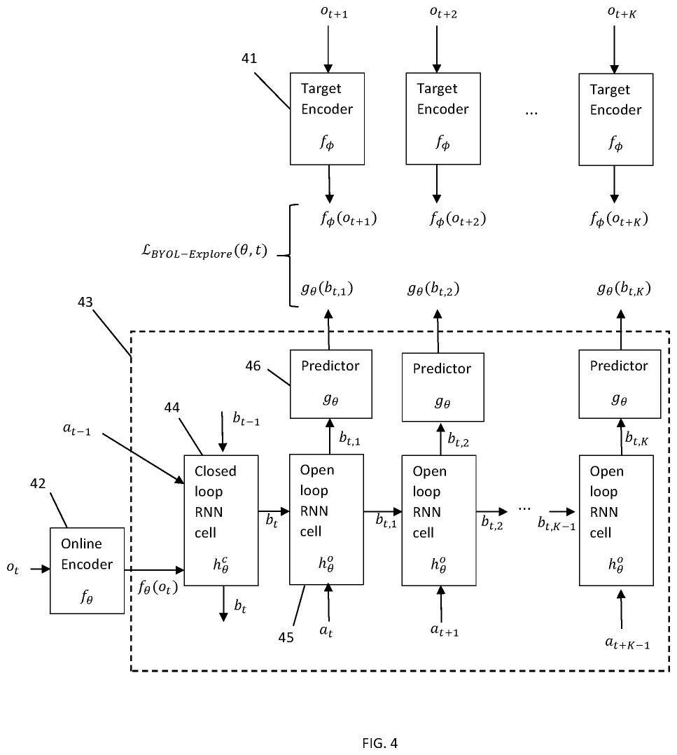

The intrinsic calculation unit 192 is trained using successive batches of trajectories selected from the training database 191. The trajectories of one batch are labelled by an integer index j. For simplicity, in this paragraph and the following ten paragraphs, the index j will be omitted, but it is to be understood that all values having an index t should really have a superscript j. FIG. 4 shows the structure of one possible form for the intrinsic reward calculation unit 192. Specifically, the intrinsic reward calculation unit 192 includes a target encoder model 41, defined by a function denoted f_{ϕ}, which is operative to receive an observation, such as oₜ₊₁, and from it produce an encoded representation f_{ϕ}(oₜ₊₁), referred to as an “observation-representation”. The intrinsic reward calculation unit 192 further includes an online encoder model 42, defined by a function denoted f_{θ}, which is also operative to receive an observation, such as oₜ₊₁, and from it produce an observation-representation, denoted f_{θ}(oₜ₊₁). The functions f_{ϕ} and f_{θ} are defined by respective pluralities of numerical parameter which are trained.

The intrinsic reward calculation unit 192 further includes a predictive unit 43 (“world model”) which, for the t-th time step, is configured to receive an observation-representation (generated by one of the encoder models 42, 43) of the current observation oₜ, and the action performed at that time step (aₜ) and the K−1 subsequent time steps (i.e. aₜ, . . . a_{t+K-1}), and is operative to generate predictions of the encoded observation for the next time step (i.e. the encoded oₜ₊₁) and the K−1 subsequent time steps (i.e. the encoded oₜ₊₂, . . . oₜ₊ₖ).

Various forms are possible for the predictive unit 43. In the predictive unit 43 shown in FIG. 4, the predictive unit is configured to receive the observation-representation of the current observation oₜ from the online encoder model 42, i.e. f_{θ}(oₜ). The predictive unit also configured (except if/is the first time step of the trajectory) to receive the action aₜ₋₁ for the previous time step. The predictive unit 43 contains two RNN cells 44, 45 referred to as the “closed loop RNN cell” 44 and the “open loop RNN cell” 45.

The intrinsic error calculation unit 192 is designed, for a given trajectory of the batch, to work through the trajectory, time step by time step, processing it in the manner shown in FIG. 4. In each of time-step of the trajectory, say the t-th time step, the intrinsic error calculation unit processes a corresponding sequence of the data selected from the trajectory, and (for each of the time steps except the first time step of the trajectory), data generated by the closed loop RNN cell 44 for the previous time-step. In processing the observation oₜ from a current t-th time step, the intrinsic calculation unit of FIG. 4 generates data relating to the subsequent K time steps, where K is an integer greater than zero.

Note that towards the end of the trajectory, where the t-th time step of the trajectory does not have as many as K later time steps in the trajectory, the intrinsic reward calculation unit 192 only uses the data from the trajectory relating to the subsequent T−1−t time steps. In summary, to process the observation oₜ, the intrinsic error calculation unit uses data from the following min (K, T−1−t) time steps. In the following description, it will initially be assumed that t+T−K, and the converse case will then be discussed. Several variations of this scheme are possible, however. For example, the intrinsic reward calculation unit 192 might only produce an output for an observation oₜ if t<T−K.

In a given t-th time step (of the j-th trajectory), the closed loop RNN cell 44 receives the observation-representation f_{θ}(oₜ) of the corresponding observation oₜ from the online encoder model 42, and (except if the time step is the first time-step of the trajectory) the action aₜ₋₁ for the previous time step. Except if the time-step is the first time-step of a trajectory, the closed loop RNN cell 44 also receives its own output bₜ₋₁ from the previous time-step. In the time-step, the closed loop RNN cell 44 generates an output bₜ. The closed loop RNN cell 44 generates bₜ as a function, denoted h_{θ}^{c}, of f_{θ}(oₜ), aₜ₋₁ and bₜ₋₁. The function h_{θ}^{c} is defined by numerical parameters which are trained.

In a given time step 1, the open loop RNN cell 45 receives the corresponding output bₜ from the closed loop RNN 44, successively generates K outputs denoted b_{t,1}, . . . , b_{t,K}. It generates the first output b_{t,1} based on bₜ and the action for the time step aₜ. It generates each of the K−1 subsequent outputs b_{t,1}, . . . , b_{t,K} from its own previous output, and the next successive one of the actions of the sequence. The function performed by the open loop RNN cell 45 is denoted h_{θ}^{o}, and is defined by numerical parameters which are trained.

The predictive unit 43 further includes a predictor unit 46 which performs a function denoted by g_{θ}. This too is defined by a plurality of numerical parameters which are trained. The predictor unit 46 successively receives the K successive outputs of the open loop RNN cell 44, that is b_{t,1}, . . . , b_{t,K}, and for each generates a corresponding output, denoted g_{θ}(b_{t,1}), . . . , g_{θ}(b_{t,K}). These are predictions of the observation-representation of the observations for times t+1 to t+K.

For the current time step t, the target encoder model 41 is configured to receive successively the observations for the next K time steps oₜ₊₁, . . . , o_{t+K}, and from them generate K respective observation-representations f_{ϕ}(oₜ₊₁), . . . , f_{ϕ}(o_{t+K}).

Thus, if the predictive unit 43 were perfect, and if the two encoder models 41, 42 performed identical functions, then g_{θ}(b_{t,1}), . . . , g_{θ}(b_{t,K}) would be equal to f_{ϕ}(oₜ₊₁), . . . , f_{ϕ}(o_{t+K}). In reality a predictive loss value may be defined which is indicative of a discrepancy between the predictions of the observation-representations g_{θ}(b_{t,1}), . . . , g_{θ}(b_{t,K}) and the observation-representations f_{ϕ}(oₜ₊₁), . . . , f_{ϕ}(o_{t+K}) obtained from the target encoder model.

Specifically, for the observation oₜ₊ₖ at time t+k for the j-th trajectory of the batch, this predictive loss value may be defined as the average cosine difference:

$${ℒ}_{BYOL - Explore} ( θ , j , t , k ) = {‖ \frac{{g}_{θ} ( {b}_{t , k}^{j} )}{{‖ {g}_{θ} ( {b}_{t , k}^{j} ) ‖}_{2}} - sg \frac{{f}_{ϕ} ( {o}_{t + k}^{j} )}{{‖ {f}_{ϕ} ( {o}_{t + k}^{j} ) ‖}_{2}} ‖}_{2}^{2} . \qquad ( 1 )$$

Here ∥·∥₂² denotes the square of the Euclidean norm. “sg” does not alter the value of the predictive loss value. It is a notation for a “stop gradient” operator, which means that in the optimization algorithm based on the predictive loss values which is described below, backpropagation is not applied the parameters ϕ (i.e. the trainable parameters in the terms which follow “sg”).

Thus, another predictive loss value [symbol] _{BYOL-Explore}(θ) can be defined, as a sum (normalized for B and T, and the horizon K) over the trajectories j of the batch, of a sum over the sequences t for a given trajectory, of a sum over the observations k of each sequence, as:

$${ℒ}_{BYOL - Explore} ( θ ) = \frac{1}{B ( T - 1 )} {\sum }_{j = 0}^{B - 1} {\sum }_{t = 0}^{T - 2} \frac{1}{K ( t )} {\sum }_{k = 1}^{K ( t )} {ℒ}_{BYOL - Explore} ( θ , j , t , k ) , \\ where K ( t ) = min ( K , T - 1 - t ) . \qquad ( 2 )$$

This, as explained above, is the number of time steps after a time step t in a trajectory of length T (that is, the “open-loop horizon” for a sequence beginning at time t).

The predictive loss values are used in two ways: to update the variable numerical parameters of the online encoder model 42 and predictive unit 43; and to define respective intrinsic reward values for each of the actions of each trajectory in the training database.

As for the first of these, it is performed by iteratively minimizing the predictive loss value of Eqn. (2) with respect to the variable numerical parameters θ of the online encoder 42 and the predictive unit 43 (that is, the variable numerical parameters defining the closed loop RNN cell 44, the open loop RNN cell 45 and the predictor 46). Term(s) in the predictive loss value based on f_{ϕ}(oₜ₊ₖ^{j}) are not back-propagated in the algorithm to update parameters of the target encoder model; that is, the target encoder model may only be updated as described below, based on the current online encoder model.

As noted above, the second use of the predictive loss value is to define intrinsic reward values for the actions of the trajectories stored in the training database 191. The intrinsic reward value for each action is combined with the task reward for the corresponding action, to give a total reward value for the action. This total reward value is used by the (e.g. conventional) update unit 193 to update the policy neural network 122, in one iteration of training the policy neural network 122.

Specifically, the intrinsic reward term lₜ^{j} for a given action aₜ^{j} in the training database is the uncertainty associated with the transition (oₜ^{j}, aₜ^{j}, oₜ₊₁^{j}), which is the sum of the corresponding predictive loss values:

$${l}_{t}^{j} = {\sum }_{p + q = t + 1} {ℒ}_{BYOL - Explore} ( θ , j , p , q ) , \qquad ( 3 )$$

where the sum is over 0≤p≤T−2 and 1≤q≤K, and 0≤t≤T−2. This accumulates all the losses corresponding to the world-model uncertainties relative to the observation oₜ₊₁^{j}. Thus, the intrinsic reward for the action at is based on how difficult it was to predict the observation oₜ₊₁^{j} from the past partial histories. This intrinsic reward value thus rewards actions which lead to obtaining more new information about the environment.

In summary, to obtain the intrinsic reward lₜ^{j} for the action aₜ^{j} (i.e. the action at time t of the j-th trajectory), the intrinsic reward calculation unit 192 works through that trajectory time step-by-time step, and upon reaching time step t determines the corresponding intrinsic reward lₜ^{j} by the process shown in FIG. 4, using aₜ₋₁^{j} and a “sequence” starting at time-step t which is {oₜ^{j}, aₜ^{j}, oₜ₊₁^{j}, aₜ₊₁^{j}, . . . o_{t+K-1}^{j}, a_{t+K-1}^{j}, o_{t+K}^{j}}. Thus, the sequence includes a first observation oₜ^{j} and K successive observations, as well as the K actions which immediately preceded the K successive observations. The sequence may alternatively be defined to include aₜ₋₁^{j} in addition, so that the sequence is K+1 action-observation pairs, each of which is an action at a given time step and the observation at the following time-step.

The intrinsic reward lₜ^{j} corresponding to actions for trajectories in the training database may optionally be normalized using a normalization parameter σᵣ which is an EMA estimate of the standard deviations of lₜ^{j} for different choices of j (in the range 0 to B) and t (in the range 0 to T−2). That is, the normalized intrinsic reward (which is optionally used in place of intrinsic reward lₜ^{j} to form the total reward which is used by the update unit 193 to train the policy neural network 122) may be lₜ^{j}/σᵣ. This normalization is valuable because, as the world model becomes more accurate, the prediction loss function may become small, which without the normalization might result in undesirably small intrinsic reward terms.

Alternatively or additionally, the intrinsic reward lₜ^{j} (after normalization if normalization is used) corresponding to actions for trajectories in the training database may be “clipped” to a lower value (e.g. set to zero) in the case that the intrinsic reward is below a threshold, denoted μ. The threshold μ may be an adjusted EMA mean of the value of the (e.g. normalized) intrinsic reward over each successive batch of trajectories, i.e. in the case that normalization is present

$${( {( \frac{{l}_{t}^{j}}{{σ}_{r}} )}_{t = 0}^{T - 2} )}_{j = 0}^{B - 1} .$$

This has the advantage that the agent learns to concentrate initially on parts of the environment where the predictive unit 43 (world model) is most inaccurate, and the intrinsic rewards are therefore highest. As the predictive unit 43 learns during the training to predict those parts of the environment, the value of μ naturally falls, and those parts of the environment for which, when the agent generated actions exploring them, the intrinsic rewards were previously clipped, become those with the highest values of lₜ^{j}, and the predictive model focuses on them. Thus, the clipping mechanism allows the agent, at any given time during the training, to optimize only the source of the highest uncertainties, and not try to optimize all uncertainties at once.

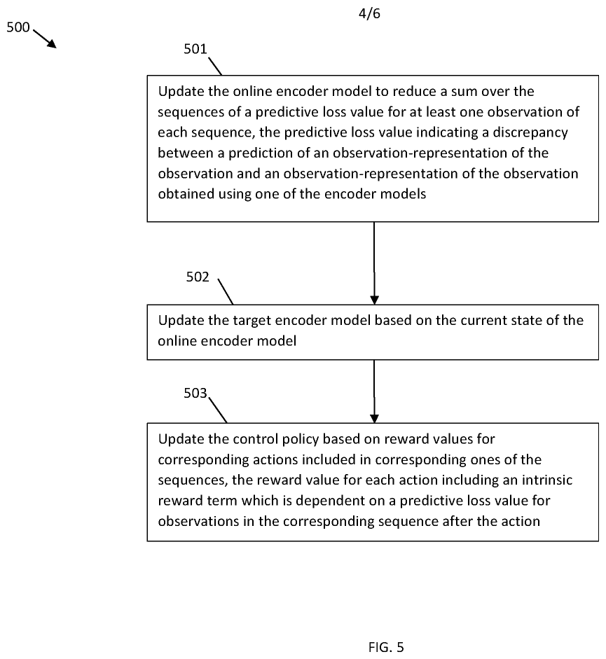

FIG. 5 shows an example training method 500. The method 500 is an example of a method implemented by computer programs on one or more computers in one or more locations.

In step 501, the online encoder model is updated to reduce the sum, e.g. given by Eqn. (2), over the sequences of a predictive loss value for at least one observation of each sequence (in the case of Eqn. (2), a predictive loss value for each observation of the sequence other than the first). The predictive loss value indicates a discrepancy between a prediction of an observation-representation of the observation (e.g. g_{θ}(b_{t,k}^{j})) and an observation-representation (e.g. f_{ϕ}(oₜ₊ₖ^{j})) of the observation obtained using one of the encoder models (e.g. the target encoder model 41 in FIG. 4, though in a variation of FIG. 4 the online encoder model 42 could be used instead).

In step 502, the target encoder model 41 is updated based on the current state of the online encoder model 42, to bring it closer to the online encoder model 42. For example, the target encoder model 41 may be updated each time the online encoder model 42 is updated (or whenever a certain number of updates to the online encoder model 42 are carried out, e.g. every tenth time that the online encoder model 42 is updated), so that the target encoder model 41 is an exponential moving average (EMA) of the online encoder model 42. That is, the variable numerical weights ϕ of the target encoder model may be updated to be equal to αϕ+ (1−α)θ, where α is a hyper-parameter called the target network EMA parameter. This hyper-parameter may be set by trial-and-error, but may for example be between 0.9 and 1.

In step 503, the control policy of the policy neural network 122 (e.g. the Q network 223 of FIG. 2, or the policy model 323 of FIG. 3) is updated according to the (e.g. conventional) reinforcement learning method, based on the trajectories in the training database 191 and, for each action in those trajectories, a corresponding reward value. The reward value (“total” reward value) for each action is the sum of the task reward for the action (which is already stored in the training database 191) and an intrinsic reward term lₜ^{j} which, as defined by Eqn. (3), is generated by the intrinsic reward calculation unit 192 using the target encoder model 41, the online encoder model 42, and the predictive unit 42 The intrinsic reward term lₜ^{j} is dependent on a predictive loss value for observations after the action.

The set of steps 501-503 may be carried out repeatedly in successive iterations (as noted above, step 502 may be omitted from some of these iterations), to jointly train the variable numerical parameters of the policy neural network 122 and the numerical parameters θ, ϕ of the intrinsic reward calculation unit 192.

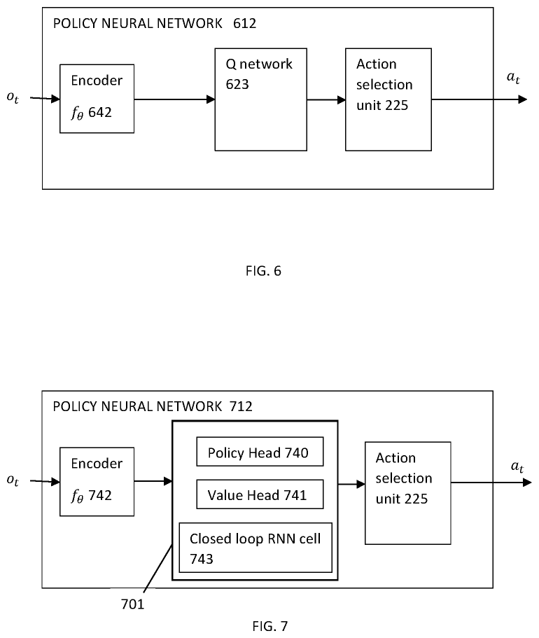

Optionally, the policy neural network 122 may include duplicated (“shared”) elements from the intrinsic reward calculation unit 192. In a first example, the policy neural network 122 of FIG. 1 may take the form of the policy neural network 612 of FIG. 6. This is similar to the policy neural network 222 of FIG. 2, in that it includes a Q network 623 and an action selection network 225. However, in the policy neural network 612, a received observation oₜ is initially encoded by an encoder 642 identical to the online encoder model 42 of the intrinsic reward calculation unit 192. Whenever an update is made to the online encoder model 42 during its training, e.g. in step 501 of the method 500 of FIG. 5, the same update is made to the encoder 642. The training of the policy neural network performed in step 503 of method 500 is to update the Q network 623 (without varying the encoder 642). Thus, the Q network 623 is iteratively trained to operate based on observation-representations generated by the encoder 642, rather than raw observations. This means that the Q network may be smaller than the Q network 223, since each observation representation is smaller (fewer bytes) than the observation it is produced from, since the encoders 41, 42 typically generate, from inputs, outputs having fewer components than the inputs.

In another example, the policy neural network 122 of FIG. 1 may take the form of the policy neural network 712 of FIG. 7. This is similar to the policy neural network 612 of FIG. 6, in that it includes an encoder 723 identical to the online encoder model 42, and an action selection network 225. However, in the policy neural network 712, the observation-representation generated by the encoder 742 from a received observation oₜ is processed to produce a policy output by a policy model unit 701 having multiple heads, including a policy head 740, a value head 741 and an RNN cell 743, playing the role of a prediction head. The RNN cell 743 may be identical to the closed loop RNN cell 44 of the predictive unit 43 of FIG. 4. The use of a control policy including a policy head and a value head is well-known in the field of reinforcement learning, and RNN cell 743 aids the control policy, e.g. by supplying inputs to the value head 741 which predict the observation which results from the agent performing any given action, so that the value head 741 can predict the values of sequences of actions selected by the policy head 740. Whenever updates are made to the online encoder model 42 and the RNN cell 44, in step 501 of the method 500 of FIG. 5, corresponding updates are made to the encoder 742 and the RNN cell 743. The training of the policy neural network 712 performed in step 503 of method 500 may be to update the policy head 740 and the value head 741 of the unit 701, without varying the encoder 742 or the RNN cell 743. Thus, the unit 701 is iteratively trained to define a control policy, based on observation-representations generated by the encoder 742, while benefiting from the predictions made by the RNN cell 743.

Note that in a variation of the method 500, the steps 501 and 502 may be performed iteratively many times, before step 503 is performed. Thus, the online encoder model 42 and predictive unit 43 are fully trained before any training is performed on the policy neural network 122. This may be appropriate in a case in which a training database 191 of trajectories relating to the environment is available (e.g. from training an agent to perform another task in the environment, e.g. by a conventional method). The policy neural network 122 may incorporate one or more elements of the trained intrinsic reward calculation unit 192 (e.g. the policy neural network 122 of FIG. 2 may be implemented by one of the policy neural networks 612, 712 of FIG. 6 or 7).

Optionally, the use of the intrinsic reward term may optionally be omitted when training the policy model of the policy neural network 122 in step 503 of method 500. That is, the system shown in FIG. 4, rather than being used as part of an intrinsic reward calculation unit 192 to calculate intrinsic reward values as explained above, may have the sole function of generating a trained encoder model and/or predictive unit, which are included an (e.g. subsequently trained) policy neural network 122.

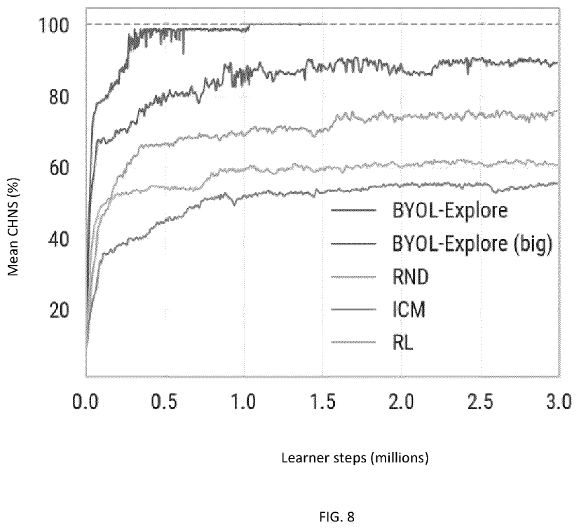

Turning to FIG. 8, experimental results are shown. The algorithm presented above has 4 main hyper-parameters: the target network EMA parameter α; the open-loop horizon K; choosing whether to clip rewards (“clipping”); and choosing whether to use the online encoder network in the policy neural network 122 so as to share the observation-representations with the policy neural network 122 (“sharing”) as in FIGS. 6 and 7. Additionally, a mixing parameter λ can be defined such that the reward value used by the update unit 193 for a given action aₜ^{j} is a linear combination of the corresponding task reward rₜ^{j} and the corresponding intrinsic reward lₜ^{j}, i.e. rₜ^{j}+λlₜ^{j}. Experiments testing all these hyper-parameters were carried out, but FIG. 8 shows only the case of α=0.99, K=8, and λ=0.1, with clipping and sharing being used.

The update unit 193 used the V-MPO algorithm (see above). The tasks to be optimized were 10 games from the Atari Learning Environment (M. Bellemare et al, “The Arcade Learning Environment: An evaluation platform for general agents”, 2013), a widely used reinforcement learning benchmark. These are mostly 2-dimensional, fully-observable, (fairly) deterministic environments. The performance of the examples was evaluated, to give a score at learner step/denoted by Agent_{score}(t), as measured by undiscounted episode return. The highest agent score through training was defined as Agent_{score}=maxₜAgent_{score}(t). Denoting the performance in the game when actions are selected at random by Random_{score}, and the score by a human by Human_{score}, a human normalized score (HNS) at learner step t is defined by:

$$HNS ( t ) = \frac{{Agent}_{score} ( t ) - {Random}_{score}}{{Human}_{score} ( t ) - {Random}_{score}} .$$

A clipped human normalized score (CHNS) was defined as HNS clipped between 0 and 1, and the results were averaged over all 10 games.

The training of the policy unit 701 employed the intrinsic reward values generated according to Eqn. (3) as explained above with reference to FIG. 5.

Two examples of the present techniques were tested, as shown respectively in FIG. 8 as “BYOL-Explore” and “BYOL-Explore (big)”. These used respectively trajectories of length 64 and length 128, but in the latter case only half the learner steps were used to keep the total computation performed roughly equivalent. In both cases the policy neural network 122 had the structure of the policy neural network 712 in FIG. 7.

In both cases, the encoder models 41, 42 transformed the observations into vectors of length N (i.e. with N real valued components) which was equal to 512. The encoder models 41, 42 were instantiated as a Deep ResNet stack, in which the greyscale image observation was passed through a stack of 3 units, each comprising a 3×3 convolutional layer, a 3×3 maxpool layer and 2 residual blocks. The number of channels for the convolutional layer and the residual blocks were 16, 32 and 32 within each of the 3 units respectively. GroupNorm normalization was used with one group at the end of each of the 3 units, and ReLU activations were used everywhere. The output of the final residual block was flattened and projected using a single linear layer to an embedding of dimension 512.

The outputs of the closed-loop RNN cell 44 and of the open-loop RNN cell 45 were vectors with M=256 real valued components. Both were implemented as simple Gated Recurrent Units.

The policy head 740, value head 741 and predictor 46 were implemented as multi-layer perceptrons (MLP) with hidden layer sizes of (512), (512) and (128, 256, 512) respectively. The policy neural network 112 (which as noted had the form of the policy neural network 712 of FIG. 7), used different linear projections of the shared hidden layer to compute components of the policy over different parts of the action space. The action space had a mix of both discrete actions (modeled using a softmax layer of logits computed as a linear projection of the hidden layer) and continuous actions (modeled as Gaussian distributions over each dimension with the mean and variance modeled using a linear projection of the hidden layer).

For comparison, training was also performed on three comparative examples: “RND” (Random Network Distillation, as disclosed in “Exploration by Random Network Distillation”, Y. Burda et al, 2019); ICM (Intrinsic Curiosity Module, as disclosed in D. Pathak et al, “Curiosity-driven exploration by self-supervised prediction”, 2017); and “RL” which was pure reinforcement learning (i.e. the update unit 193 operated in just the same way as in the embodiments but using reward values which were just the task rewards, not including the intrinsic rewards; in effect this is the case λ=0).

BYOL-Explore (big) achieved an HNS greater than one (i.e. “superhuman”) on all of the 10 hardest exploration games. As can be seen from FIG. 8, the mean CHMS over the 10 games reached 100% after about 1 million learner steps. BYOL-Explore was slightly less successful, but still more successful than the RND, ICM and RL baselines.

Some possible environments for which the present disclosure may be useful are now discussed. In this discussion “rewards” and “returns” relate to extrinsic rewards.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and other sensor data to capture observations as the agent interacts with the environment, for example sensor data from an image, distance, or position sensor or from an actuator.

For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands.

The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment, such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The extrinsic rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The extrinsic rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential drug and the agent is a computer system for determining elements of the drug and/or a synthetic pathway for the drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, the reinforcement learning system may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system. The reinforcement learning system chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. During an on-policy training phase and/or another phase in which the history database is being generated, the experience tuples may record the action which the user actually performed based on the instruction, rather than the one which the reinforcement learning system instructed the user to perform. The reward value of each experience tuple may be generated, for example, by comparing the action the user took with a corpus of data showing a human expert performing the task, e.g. using techniques known from imitation learning. Note that if the user performs actions incorrectly (i.e. performs a different action from the one the reinforcement learning system instructs the user to perform) this adds one more source of noise to sources of noise which may already exist in the environment. During the training process the reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

As an illustrative example a user may be interacting with a digital assistant and ask for help performing an overall task consisting of multiple steps, e.g. cooking a pasta dish. While the user performs the task, the digital assistant receives audio and/or video inputs representative of the user's progress on the task, e.g. images or video or sound clips of the user cooking. The digital assistant uses a system as described above, in particular by providing it with the captured audio and/or video and a question that asks whether the user has completed a particular step, e.g. ‘Has the user finished chopping the peppers?’, to determine whether the user has successfully completed the step. If the answer confirms that the use has successfully completed the step then the digital assistant progresses to telling the user to perform the next step or, if at the end of the task, or if the overall task is a single-step task, then the digital assistant may indicate this to the user. The digital assistant may then stop receiving or processing audio and/or video inputs to ensure privacy and/or reduce power use.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as LaMDA, Sparrow, or Chinchilla. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In the implementations above, the environment may not include a human being or animal. In other implementations, however, it may comprise a human being or animal. For example, the agent may be an autonomous vehicle in an environment which is a location (e.g. a geographical location) where there are human beings (e.g. pedestrians or drivers/passengers of other vehicles) and/or animals, and the autonomous vehicle itself may optionally contain human beings. The environment may also be at least one room (e.g. in a habitation) containing one or more people. The human being or animal may be an element of the environment which is involved in the task, e.g. modified by the task (indeed, the environment may substantially consist of the human being or animal). For example the environment may be a medical or veterinary environment containing at least one human or animal subject, and the task may relate to performing a medical (e.g. surgical) procedure on the subject. In a further implementation, the environment may comprise a human user who interacts with an agent which is in the form of an item of user equipment, e.g. a digital assistant. The item of user equipment provides a user interface between the user and a computer system (the same computer system(s) which implement the reinforcement learning system, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. In this way, a personalized system may be provided for the user to control the computer system, again tailored to the aptitudes and current knowledge of the user.

Optionally, in any of the above implementations, the observation at any given time step may include data from a previous time step that may be beneficial in characterizing the environment, e.g., the action performed at the previous time step, the reward received at the previous time step, or both.

The subject matter described in this specification can be implemented in particular embodiments so as to realize the advantages described above.

Further advantages are that implementations of the system are able to learn to perform tasks that are difficult or impossible for other systems to learn. For example the system can explore an environment and possible actions more effectively than some other, more complex systems, leading to faster, more efficient learning and the ability to solve tasks in difficult-to-explore environments. Thus the system can also reduce the memory and computational resources needed to learn a task. Implementations of the system can learn difficult tasks without the need for human demonstrations, reward shaping, or curriculum learning. Implementations of the system are applicable across a wide range of application domains.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “stack” of layers refers to a sequence of layers, each of which receives a data input and produces a data output. Each of the other layers other than the first layer receives as at least part of its input, at least a part of the output of the preceding layer in the sequence. Thus, data flows through the stack from the first layer to the last layer of the sequence, and the output of the output of the stack of layers comprises the output of the last layer of the sequence.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more computers for learning a control policy, the control policy being for generating successive actions at each of corresponding successive time-steps to be performed by an agent interacting with an environment, based on observations characterizing the environment at the respective ones of the time-steps,
the method employing an online encoder model and a target encoder model, which are each operative, upon receiving an observation, to generate an observation-representation, as data in a latent representation space,
wherein the online encoder model, the target encoder model and the control policy are trained by an iterative process of making respective updates to them based on sequences of observations and corresponding actions, at least the online encoder model and the target encoder model being trained jointly,
the iterative process including repeatedly:
updating the online encoder model to reduce a sum over the sequences of a predictive loss value for at least one observation of each sequence, the predictive loss value of each observation being indicative of a discrepancy between a prediction of an observation-representation of the observation and an observation-representation of the observation obtained using one of the encoder models;
updating the target encoder model based on the current state of the online encoder model; and
updating the control policy based on reward values for corresponding actions included in corresponding ones of the sequences, the reward value for each action including an intrinsic reward term which is dependent on a predictive loss value for observations in the corresponding sequence after the action and which is generated using the sequence and the online encoder model.

2. The method of claim 1, wherein the plurality of sequences of observations and actions are based on a batch of trajectories comprising observations at successive time steps and corresponding actions at the successive time steps, each of the sequences comprising a sequence of observations and actions selected from one of the trajectories.

3. The method of claim 1, wherein the predictive loss value for each observation is a measure of a difference between a predicted observation-representation of the observation generated using the online encoder model, and an observation-representation of the observation generated by the target encoder model.

4. The method of claim 3, wherein respective predicted observation-representations of each observation in a given one of the sequences except a first observation of the sequence, are generated by a predictive unit arranged to receive an input based on the observation-representation generated by the online encoder model upon receiving the first observation of the sequence.

5. The method of claim 4, wherein the predictive unit is jointly trained with the online encoder model and the target encoder model, the updates to the predictive unit being to reduce the sum over the sequences of the respective predictive loss value for each observation of each sequence except the first observation of each sequence.

6. The method of claim 5, wherein the predictive unit is arranged to generate K predicted observation-representations, where K is an integer greater than one, as successive outputs of a predictor unit of the predictive unit based on respective outputs of an open-loop recurrent cell of the predictive unit,
the open-loop recurrent cell being configured, upon receiving a first input which is based on the observation-representation generated by the online encoder model upon receiving on a first observation of the sequence, and a second input based on the action for the corresponding time step, to generate a first output, and to generate K−1 successive further outputs, each based on the previous output of the open loop recurrent cell and a corresponding action of the sequence.

7. The method of claim 6, wherein the first input to the open-loop recurrent cell is the output of a closed-loop recurrent cell of the predictive unit, the closed-loop recurrent cell being arranged to receive an observation-representation of the first observation of the sequence generated by the online encoder model, and, except if the first time-step of a sequence is the first time-step of a trajectory, an output of the closed-loop recurrent cell for the previous time-step of the trajectory.

8. The method of claim 7, wherein except if the first time-step of a sequence is the first time-step of trajectory, the closed-loop recurrent cell is further configured to receive the action from the time step of the trajectory immediately preceding the time step of the first observation in the sequence.

9. The method of claim 1, wherein the sequences are selected from a batch of trajectories selected from a training database, each trajectory being of length T time steps, labelled by an integer variable t=0, . . . , T−1, and comprising an observation and a corresponding action for each time step, each trajectory of the batch being used to generate, for each value of t from 0 to T−K−1, a corresponding one the sequences, comprising the observation and corresponding action for time t, and K successive observations and K actions at corresponding time steps.

10. The method of claim 9, wherein each trajectory of the batch is used to generate, for each value of t from T−K to T−2, a corresponding one of the sequences, comprising the observation and corresponding action for time t, and T−t−1 successive observations and T−t−1 actions at corresponding time steps.

11. The method of claim 1, wherein the intrinsic reward term for an action is based on a prediction loss function which is a sum over a plurality of observations after the action of the predictive loss value for the observations.

12. The method of claim 11, wherein the prediction loss function is normalized to form the intrinsic reward term using a normalization parameter indicative of the variance of the prediction loss function for a plurality of actions.

13. The method according to claim 11, further comprising determining whether the intrinsic reward term is below a threshold, and, upon determining that the intrinsic reward term is below the threshold, the intrinsic reward term is reduced.

14. The method of claim 1, wherein the updates to the target encoder model make the target encoder model closer to the current online encoder model.

15. The method of claim 14, wherein the target encoder model is an exponential moving average of the online encoder model.

16. The method of claim 1, wherein the control policy is defined by a policy neural network, the policy neural network comprising an encoder for receiving observations of the environment, the encoder employing the online encoder model to generate an observation-representation of the observations.

17. The method of claim 16, wherein the policy neural network further comprises a predictive model sharing at least some parameters of the predictive unit.

18. The method of claim 1, wherein the reward value for each action further includes at least one task reward term associated with a corresponding task, and indicative of a degree to which the action contributes to performance of the corresponding task.

19. (canceled)

21. A system comprising one or more computers and one or more storage devices storing instructions that when executed by the one or more computers cause the one or more computers to perform operations for learning a control policy, the control policy being for generating successive actions at each of corresponding successive time-steps to be performed by an agent interacting with an environment, based on observations characterizing the environment at the respective ones of the time-steps,
the operations employing an online encoder model and a target encoder model, which are each operative, upon receiving an observation, to generate an observation-representation, as data in a latent representation space,
wherein the online encoder model, the target encoder model and the control policy are trained by an iterative process of making respective updates to them based on sequences of observations and corresponding actions, at least the online encoder model and the target encoder model being trained jointly,
the iterative process including repeatedly:
updating the online encoder model to reduce a sum over the sequences of a predictive loss value for at least one observation of each sequence, the predictive loss value of each observation being indicative of a discrepancy between a prediction of an observation-representation of the observation and an observation-representation of the observation obtained using one of the encoder models;
updating the target encoder model based on the current state of the online encoder model; and
updating the control policy based on reward values for corresponding actions included in corresponding ones of the sequences, the reward value for each action including an intrinsic reward term which is dependent on a predictive loss value for observations in the corresponding sequence after the action and which is generated using the sequence and the online encoder model.

22. One or more computer storage media storing instructions that when executed by one or more computers cause the one or more computers to perform operations for learning a control policy, the control policy being for generating successive actions at each of corresponding successive time-steps to be performed by an agent interacting with an environment, based on observations characterizing the environment at the respective ones of the time-steps,
the operations employing an online encoder model and a target encoder model, which are each operative, upon receiving an observation, to generate an observation-representation, as data in a latent representation space,
wherein the online encoder model, the target encoder model and the control policy are trained by an iterative process of making respective updates to them based on sequences of observations and corresponding actions, at least the online encoder model and the target encoder model being trained jointly,
the iterative process including repeatedly:
updating the online encoder model to reduce a sum over the sequences of a predictive loss value for at least one observation of each sequence, the predictive loss value of each observation being indicative of a discrepancy between a prediction of an observation-representation of the observation and an observation-representation of the observation obtained using one of the encoder models;
updating the target encoder model based on the current state of the online encoder model; and
updating the control policy based on reward values for corresponding actions included in corresponding ones of the sequences, the reward value for each action including an intrinsic reward term which is dependent on a predictive loss value for observations in the corresponding sequence after the action and which is generated using the sequence and the online encoder model.
